(19) United States
(12) Patent Application Publication
(10) Pub. No.: US 2026/0228305 A1
(43) Pub. Date: Aug. 6, 2026

(54) COMPREHENSIVE RESILIENCE EVALUATION SYSTEM FOR TRADITIONAL VILLAGE

(71) Applicant: Beijing University of Civil Engineering and Architecture, Beijing (CN)

(72) Inventors: Yuefang Rong, Beijing (CN); Zhen Ren, Beijing (CN); Siwei Guo, Beijing (CN); Haoxi Lin, Beijing (CN); Mengyuan Jia, Beijing (CN); Shuhan Guo, Beijing (CN); Xiaohang Liang, Beijing (CN); Jian Song, Beijing (CN); Zilin Wang, Beijing (CN); Jingru Feng, Beijing (CN); Wanrong Yang, Beijing (CN); Jinhua Lin, Beijing (CN); Yan Liu, Beijing (CN); Yuru Liu, Beijing (CN)

(21) Appl. No.: 19/457,114

(22) Filed: Jan. 22, 2026

(30) Foreign Application Priority Data
Feb. 6, 2025 (CN) 202510132132.8

(51) Int. Cl. G06F 18/211; G06N 3/0464; G06N 3/048; G06Q 50/22

(52) U.S. Cl. CPC G06F 18/211; G06N 3/0464; G06N 3/048; G06Q 50/22

(57) ABSTRACT

A comprehensive resilience evaluation system for a traditional village is provided. The system employs a deep learning-based neural network model to perform semantic encoding on data for resilience aspects of a traditional village to be evaluated to extract semantic descriptive coding features from the multi-dimensional data for the resilience aspects of the village to be evaluated. Concurrently, the system retrieves village resilience-related data labeled with a first resilience evaluation label from a backend database as reference features. Through conducting a semantic query matching analysis based on multi-source resilience-related data between the village to be evaluated and various villages labeled with the first resilience evaluation label, the system intelligently evaluates whether the village to be evaluated possesses a resilience level corresponding to the first resilience evaluation label. Thus, the accuracy of the comprehensive resilience evaluation for the village to be evaluated can be effectively improved.

### CROSS-REFERENCE TO RELATED APPLICATION

This application claims priority to Chinese Patent Application No. 202510132132.8, filed on Feb. 6, 2025, which is herein incorporated by reference in its entirety.

### TECHNICAL FIELD

The disclosure relates to the field of intelligent evaluation, and more particularly to a comprehensive resilience evaluation system for a traditional village.

### BACKGROUND

Traditional villages are not only symbols of regional culture but also important heritage of human civilization. However, in the rapidly developing modern society, the traditional villages face a series of challenges, such as frequent natural disasters, economic decline, population outflow, and inadequate management mechanisms. These issues pose serious threats to the survival and development of the traditional villages. Therefore, evaluating the resilience of a traditional village has become key to traditional village protection and sustainable development.

Current methods for evaluating the resilience of the traditional village primarily include qualitative assessment and quantitative assessment. The qualitative assessment methods rely mainly on expert knowledge and experience to derive evaluation conclusions in a descriptive manner. While the qualitative assessment methods can, to some extent, reveal the intrinsic characteristics and potential strengths of a village, they are highly subjective and make it difficult to quantitatively compare differences between villages. The quantitative assessment methods measure village resilience by constructing mathematical models or statistical indicator systems, and can provide relatively objective evaluation results. However, the quantitative assessment methods also have limitations in practical application, such as the complexity of building indicator systems and insufficient generalization capability of the models. Whether qualitative or quantitative, it is challenging to completely avoid the influence of human factors, particularly in the process of setting evaluation criteria and assigning weights, where subjective judgments may lead to deviations in the evaluation results.

Therefore, an optimized comprehensive resilience evaluation system for the traditional village is expected.

### SUMMARY

To resolve the technical problems mentioned above, the disclosure is proposed. An embodiment of the disclosure provides a comprehensive resilience evaluation system for a traditional village. The system employs a deep learning-based neural network model to perform semantic encoding on the resilience-related data of a traditional village to be evaluated to extract semantic descriptive coding features from the multi-dimensional data for resilience aspects of the village to be evaluated. Simultaneously, the system retrieves village resilience-related data labeled with a first resilience evaluation label from a backend database to serve as reference features. By conducting a semantic query matching analysis based on multi-source resilience data between the village to be evaluated and villages labeled with the first resilience evaluation label, the system intelligently assesses whether the traditional village to be evaluated possesses a resilience level corresponding to the first resilience evaluation label. In this way, by performing comparative analysis between the village to be evaluated and the pre-labeled villages, the accuracy of the comprehensive resilience evaluation for the traditional village to be evaluated can be effectively improved.

In an aspect of the disclosure, a comprehensive resilience evaluation system for a traditional village is provided. The comprehensive resilience evaluation system for the traditional village includes: a data acquisition module, a multi-source semantic aggregation module for the resilience aspects of the traditional village to be evaluated, a first resilience evaluation label extraction module, a semantic association encoding module, a query encoding module, and a resilience evaluation module.

The data acquisition module is configured to acquire a set of data for resilience aspects of a traditional village to be evaluated.

The multi-source semantic aggregation module for the resilience aspects of the traditional village to be evaluated (also referred to as a semantic encoding module) is configured to perform semantic encoding and structured processing on the set of the data for the resilience aspects of the traditional village to be evaluated to obtain a multi-source semantic aggregation matrix for the resilience aspects of the traditional village to be evaluated.

The first resilience evaluation label extraction module is configured to extract, from a backend database, a collection of multi-source semantic aggregation reference matrices for village resilience aspects labeled with a first resilience evaluation label.

The semantic association encoding module is configured to perform semantic association encoding on the multi-source semantic aggregation matrix for the resilience aspects of the traditional village to be evaluated and the collection of multi-source semantic aggregation reference matrices for village resilience aspects, individually, to obtain a multi-source semantic aggregation implicit feature vector for the resilience aspects of the traditional village to be evaluated and a collection of multi-source semantic aggregation implicit reference feature vectors for village resilience aspects.

The query encoding module is configured to perform, based on essential features of the collection of multi-source semantic aggregation implicit reference feature vectors for village resilience aspects, cross-domain query encoding on the multi-source semantic aggregation implicit feature vector for the resilience aspects of the traditional village to be evaluated relative to the collection of multi-source semantic aggregation implicit reference feature vectors for village resilience aspects to obtain a semantic query response representation vector for the resilience aspects of the traditional village to be evaluated.

The resilience evaluation module is configured to determine, based on the semantic query response representation vector for the resilience aspects of the traditional village to be evaluated, whether to label resilience of the traditional village to be evaluated as the first resilience evaluation label.

Compared with the related art, the comprehensive resilience evaluation system for the traditional village provided by the disclosure adopts a neural network model based on deep learning to perform semantic encoding on the data for the resilience aspects of the traditional village to be evaluated, to extract the semantic description encoding features of the multi-dimensional data for the resilience aspects of the traditional village to be evaluated. Simultaneously, the system retrieves resilience-related data for villages labeled with the first resilience evaluation label from the backend database as reference features. By conducting a semantic query matching analysis based on multi-source data for resilience aspects between the traditional village to be evaluated and respective villages labeled with the first resilience evaluation label, the system intelligently assesses whether the traditional village to be evaluated has a resilience level corresponding to the first resilience evaluation label. In this way, by performing a comparative analysis between the traditional village to be evaluated and the pre-labeled villages, the accuracy of the comprehensive resilience assessment for the traditional village to be evaluated can be effectively improved.

### BRIEF DESCRIPTION OF DRAWINGS

By providing a more detailed description of the embodiments of the disclosure in conjunction with the accompanying drawings, the above and other objectives, features, and advantages of the disclosure will become more apparent. The accompanying drawings are used to provide further understanding of the embodiments of the disclosure and form a part of the specification. They are used together with the embodiments of the disclosure to explain the disclosure and do not constitute limitations on the disclosure. In the accompanying drawings, the same reference numbers usually represent the same components or steps.

FIG. 1 illustrates a block diagram of a comprehensive resilience evaluation system for a traditional village according to an embodiment of the disclosure.

FIG. 2 illustrates a schematic data flow diagram of the comprehensive resilience evaluation system for the traditional village according to the embodiment of the disclosure.

FIG. 3 illustrates a block diagram of a query encoding module of the comprehensive resilience evaluation system for the traditional village according to the embodiment of the disclosure.

FIG. 4 illustrates a block diagram of a multi-source semantic aggregation module for resilience aspects of a traditional village to be evaluated of the comprehensive resilience evaluation system for the traditional village according to the embodiment of the disclosure.

FIG. 5 illustrates a block diagram of a semantic expression hierarchical modulation unit of the comprehensive resilience evaluation system for the traditional village according to the embodiment of the disclosure.

FIG. 6 illustrates a block diagram of a cross-domain query encoding unit of the comprehensive resilience evaluation system for the traditional village according to the embodiment of the disclosure.

### DETAILED DESCRIPTION OF EMBODIMENTS

The exemplary embodiments according to the disclosure will be described in detail below with reference to the accompanying drawings. Apparently, the described embodiments are only a part of the embodiments of the disclosure, and not the entire embodiments of the disclosure. It should be understood that the disclosure is not limited by the exemplary embodiments described herein.

As used in the disclosure and the claims, unless the context clearly indicates otherwise, the terms “a”, “an”, and/or “the” do not denote a singular form and may also include a plural form. In general, the terms “comprise” and “include” merely indicate that the clearly identified steps and elements are included, and these steps and elements do not constitute an exhaustive enumeration; the method or device may also include other steps or elements.

Although various references are made to certain modules in the system according to embodiments of the disclosure, any number of different modules may be used and run on user terminals and/or servers. The modules described are illustrative only, and different aspects of the system and method may use different modules.

A flowchart is used in the disclosure to illustrate the operations performed by the system according to the embodiments of the disclosure. It should be understood that the preceding or following operations may not be executed precisely in order. On the contrary, various steps can be processed in reverse order or simultaneously as needed. At the same time, other operations can also be added to these processes, or a step or steps can be removed from these processes.

Below, the exemplary embodiments according to the disclosure will be described in detail with reference to the accompanying drawings. Apparently, the described embodiments are only a part of the embodiments of the disclosure, and not the entire embodiments of the disclosure. It should be understood that the disclosure is not limited by the exemplary embodiments described herein.

Current methods for evaluating the resilience of the traditional village primarily include qualitative assessment and quantitative assessment. The qualitative assessment methods rely mainly on expert knowledge and experience to derive evaluation conclusions in a descriptive manner. While the qualitative assessment methods can, to some extent, reveal the intrinsic characteristics and potential strengths of a village, they are highly subjective and make it difficult to quantitatively compare differences between villages. The quantitative assessment methods measure village resilience by constructing mathematical models or statistical indicator systems, and can provide relatively objective evaluation results. However, the quantitative assessment methods also have limitations in practical application, such as the complexity of building indicator systems and insufficient generalization capability of the models. Whether qualitative or quantitative, it is challenging to completely avoid the influence of human factors, particularly in the process of setting evaluation criteria and assigning weights, where subjective judgments may lead to deviations in the assessment results. Therefore, an optimized comprehensive resilience evaluation system for the traditional village is expected.

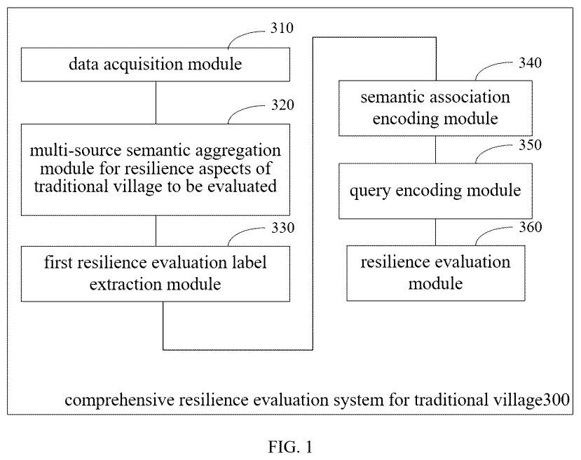

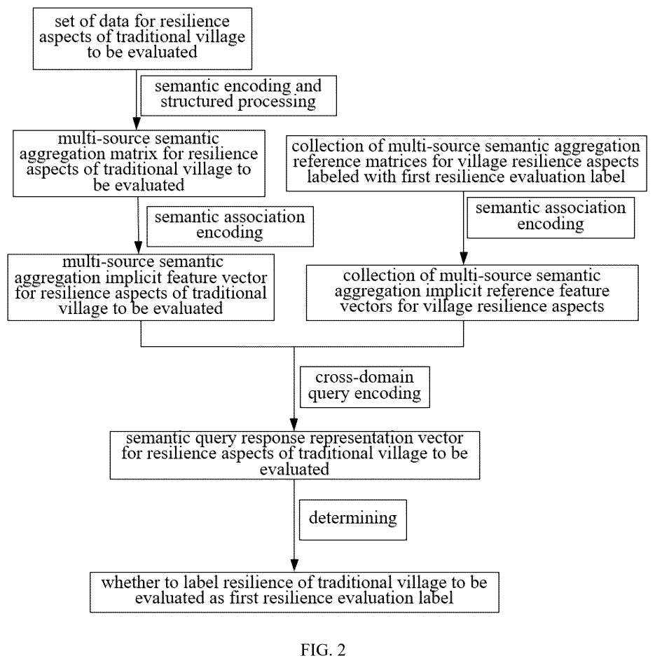

In the technical solutions of the disclosure, a comprehensive resilience evaluation system for a traditional village is proposed. FIG. 1 illustrates a block diagram of a comprehensive resilience evaluation system for a traditional village according to an embodiment of the disclosure. FIG. 2 illustrates a schematic data flow diagram of the comprehensive resilience evaluation system for the traditional village according to the embodiment of the disclosure. As shown in FIGS. 1-2, the comprehensive resilience evaluation system for the traditional village 300 includes a data acquisition module 310, a multi-source semantic aggregation module for the resilience aspects of the traditional village to be evaluated 320, a first resilience evaluation label extraction module 330, a semantic association encoding module 340, a query encoding module 350, and a resilience evaluation module 360. The data acquisition module 310 is configured to acquire a set of data for resilience aspects of a traditional village to be evaluated. The multi-source semantic aggregation module for the resilience aspects of the traditional village to be evaluated 320 is configured to perform semantic encoding and structured processing on the set of the data for the resilience aspects of the traditional village to be evaluated to obtain a multi-source semantic aggregation matrix for the resilience aspects of the traditional village to be evaluated. The first resilience evaluation label extraction module 330 is configured to extract, from a backend database, a collection of multi-source semantic aggregation reference matrices for village resilience aspects labeled with a first resilience evaluation label. The semantic association encoding module 340 is configured to perform semantic association encoding on the multi-source semantic aggregation matrix for the resilience aspects of the traditional village to be evaluated and the collection of multi-source semantic aggregation reference matrices for village resilience aspects, individually, to obtain a multi-source semantic aggregation implicit feature vector for the resilience aspects of the traditional village to be evaluated and a collection of multi-source semantic aggregation implicit reference feature vectors for village resilience aspects. The query encoding module 350 is configured to perform, based on essential features of the collection of multi-source semantic aggregation implicit reference feature vectors for village resilience aspects, cross-domain query encoding on the multi-source semantic aggregation implicit feature vector for the resilience aspects of the traditional village to be evaluated relative to the collection of multi-source semantic aggregation implicit reference feature vectors for village resilience aspects to obtain a semantic query response representation vector for the resilience aspects of the traditional village to be evaluated. The resilience evaluation module 360 is configured to determine, based on the semantic query response representation vector for the resilience aspects of the traditional village to be evaluated, whether to label resilience of the traditional village to be evaluated as the first resilience evaluation label.

Specifically, the data acquisition module 310 is configured to acquire the set of the data for the resilience aspects of the traditional village to be evaluated. The data for the resilience aspects includes descriptions of a physical environment, descriptions of economic conditions, descriptions of socio-cultural aspects, and descriptions of management mechanisms. It should be understood that the resilience of the traditional village is influenced by multiple factors, and the factors interact with each another and jointly determine the resistance and recovery ability of the village. In an embodiment, the physical environment is the foundation for the survival and development of the traditional village, including geographical location, natural landscapes, ecological environment, and infrastructure. By assessing the physical environment of the village to be evaluated, the capacity to withstand natural disasters of the village, the health status of the ecological environment, and the completeness of the infrastructure can be understood, thereby providing a basis for improving the physical environment. The economic conditions reflect the economic vitality and development potential of the village, including income levels, industrial structure, and employment opportunities. By assessing the economic conditions of the village to be evaluated, the economic strengths and weaknesses of the village can be identified; and the quality of economic conditions directly impacts living standards of residents and the sustainable development of the village. The socio-cultural aspects are what give the traditional village its unique charm, including historical heritage, folk customs, and community relations. By evaluating the socio-cultural aspects of the village to be evaluated, the status of cultural heritage preservation, community cohesion, and residents' sense of identity can be understood. The management mechanisms are crucial for ensuring the orderly operation and sustainable development of the village, including governance structures, rules and regulations, and community participation. By evaluating the management mechanisms of the village to be evaluated, problems and shortcomings in governance can be found, facilitating the optimization of the management structure and improvement of governance effectiveness. In the technical solutions of the disclosure, by analyzing data across multiple dimensions, a more comprehensive reflection of the actual situation of the traditional village can be achieved, avoiding the one-sidedness and limitations caused by single-dimension assessments.

The data related to the physical environment is primarily sourced from geographic information system (GIS) data, remote sensing imagery data, environmental monitoring data, and historical disaster records. These data help us understand the geographical location, topography, climatic conditions, natural landscapes, vegetation coverage, water distribution, air quality, water quality, soil quality, and past natural disaster situations of the village. In an embodiment, firstly, relevant data is collected through various means such as field surveys, questionnaire surveys, remote sensing technology, and environmental monitoring equipment. For instance, drones can be employed for aerial photography to acquire high-resolution images of terrain and vegetation; environmental monitoring stations can be installed to periodically collect air and water quality data. Next, the collected data undergoes cleaning and standardization to ensure consistency and comparability. Specific steps include deduplication, filling in missing values, and handling outliers. Finally, the processed data is stored in a database for subsequent analysis and retrieval. A database table can be designed with fields such as geographical location, topography, climatic conditions, environmental monitoring data, and historical disaster records to ensure efficient data management and querying.

Data related to the economic conditions is primarily sourced from economic statistical data provided by statistical bureaus and local governments, information on the number, scale, and industry distribution of enterprises within the village, and economic activities and consumption habits of villagers obtained through questionnaires, interviews, and other methods. In an embodiment, economic statistical data obtained through official channels is first acquired and a census or sample survey of enterprises within the village is conducted. For instance, the latest economic census data may be downloaded from the statistical bureau or data on household income and expenditure is collected through questionnaires. Next, the collected economic data is subjected to statistical analysis to identify the economic strengths and weaknesses of the village. Statistical software (such as statistical package for the social sciences, abbreviated as SPSS, or R language) may be used for data analysis, generating charts and reports to visually illustrate the economic conditions. Finally, economic data from different sources are integrated to form a comprehensive description of the economic conditions. A database table can be designed with fields such as per capita income, employment rate, number of enterprises, and industrial structure to ensure data completeness and consistency.

Data related to the socio-cultural aspects is primarily sourced from information on the historical evolution, cultural heritage, and traditional festivals of the village, and social relations, community cohesion, and cultural identity of villagers obtained through questionnaires and interviews, along with documentary materials such as local gazetteers, academic papers, and news reports. In an embodiment, socio-cultural data is collected through various methods such as field surveys, literature review, and community surveys. For instance, it is possible to visit local elders to record their oral histories, consult local chronicles to understand historical changes of the village, and use questionnaires to understand villagers' awareness of and participation in traditional culture. Next, the collected data is organized and categorized to ensure data completeness and accuracy. A database table can be designed with fields such as historical evolution, cultural heritage, traditional festivals, and community cohesion to facilitate efficient data management and querying. Finally, the organized data is stored in a database for subsequent analysis and retrieval. Relational databases (such as MySQL or PostgreSQL) may be used to store the data, ensuring data security and integrity.

Data related to the management mechanisms is primarily sourced from policy documents and regulations issued by local governments regarding village management, community management records of the village (such as meeting minutes and activity logs), and satisfaction and suggestions of villagers for community management obtained through questionnaires, interviews, and other methods. In an embodiment, firstly, government documents are acquired through official channels, community management records are organized, and resident surveys are conducted. For instance, the latest policy documents may be downloaded from the local government website, community meeting minutes and activity logs may be collected; and questionnaires are used to gather the satisfaction and suggestions of villagers for community management. Next, the collected management mechanism data is analyzed to identify problems and shortcomings in management. Text analysis tools (such as Python natural language toolkit (NLTK) library) may be used for sentiment analysis of textual data to understand attitudes and opinions of villagers toward community management. Finally, management mechanism data from different sources are integrated to form a complete description of the management mechanisms. A database table can be designed with fields such as policy documents, community management records, and resident satisfaction to ensure data completeness and consistency.

In an embodiment, the multi-source semantic aggregation module for the resilience aspects of the traditional village to be evaluated 320 includes: a semantic encoding unit and a matrix arrangement unit. The semantic encoding unit is configured to perform the semantic encoding on the descriptions of the physical environment, the descriptions of the economic conditions, the descriptions of the socio-cultural aspects, and the descriptions of the management mechanisms, individually, to obtain a collection of description semantic encoding vectors for the resilience aspects of the traditional village to be evaluated, wherein the collection of description semantic encoding vectors for the resilience aspects of the traditional village to be evaluated comprises a physical environment description semantic encoding vector, an economic condition description semantic encoding vector, a socio-cultural aspect description semantic encoding vector, and a management mechanism description semantic encoding vector. The matrix arrangement unit is configured to arrange the collection of description semantic encoding vectors for the resilience aspects of the traditional village to be evaluated into a matrix to obtain the multi-source semantic aggregation matrix for the resilience aspects of the traditional village to be evaluated.

Specifically, the multi-source semantic aggregation module for the resilience aspects of the traditional village to be evaluated 320 is configured to perform the semantic encoding and structured processing on the set of the data for the resilience aspects of the traditional village to be evaluated to obtain the multi-source semantic aggregation matrix for the resilience aspects of the traditional village to be evaluated. In an embodiment of the disclosure, firstly, the semantic encoding is performed on the descriptions of the physical environment, the descriptions of the economic conditions, the descriptions of the socio-cultural aspects, and the descriptions of the management mechanisms, individually, to obtain a collection of description semantic encoding vectors for the resilience aspects of the traditional village to be evaluated, the collection of description semantic encoding vectors for the resilience aspects of the traditional village to be evaluated includes a physical environment description semantic encoding vector, an economic condition description semantic encoding vector, a socio-cultural aspect description semantic encoding vector, and a management mechanism description semantic encoding vector. Here, considering that the descriptions of the physical environment, the descriptions of the economic conditions, the descriptions of the socio-cultural aspects, and the descriptions of the management mechanisms all exist in the form of natural language, which cannot be directly understood or processed by computers, the natural language processing technology is used in the technical solutions of the disclosure to perform the semantic encoding on the descriptions of the physical environment, the descriptions of the economic conditions, the descriptions of the socio-cultural aspects, and the descriptions of the management mechanisms to effectively extract and process the semantic information contained within the textual descriptions for the resilience aspects, to thereby obtain the physical environment description semantic encoding vector, the economic condition description semantic encoding vector, the socio-cultural aspect description semantic encoding vector, and the management mechanism description semantic encoding vector. Subsequently, the collection of description semantic encoding vectors for the resilience aspects of the traditional village to be evaluated is arranged into a matrix so as to organically integrate data from different domains of for the resilience aspects of the traditional village to be evaluated (i.e., the physical environment, economic conditions, socio-cultural aspects, and management mechanisms) and form a comprehensive representation of the multi-source data for the resilience aspects of the traditional village to be evaluated, to thereby obtain the multi-source semantic aggregation matrix for the resilience aspects of the traditional village to be evaluated, which facilitates comprehensive analysis and evaluation.

Specifically, the first resilience evaluation label extraction module 330 is configured to extract, from the backend database, the collection of multi-source semantic aggregation reference matrices for village resilience aspects labeled with the first resilience evaluation label. That is, a dataset for village resilience aspects labeled with the first resilience evaluation label is obtained from the backend database. Similarly, the semantic encoding and structured processing are performed on the dataset for village resilience aspects labeled with the first resilience evaluation label to obtain the collection of multi-source semantic aggregation reference matrices for village resilience aspects labeled with the first resilience evaluation label. The backend database is stored with a large volume of village resilience evaluation data, which has been validated through extensive historical experience and data, thus possessing referential value for village resilience evaluation. Therefore, in the technical solutions of the disclosure, the data for resilience aspects (the physical environment, economic conditions, socio-cultural aspects, and management mechanisms) of respective villages labeled with the first resilience evaluation label can be used as reference data; and after undergoing the semantic encoding and matrix arrangement processing, the collection of multi-source semantic aggregation reference matrices for village resilience aspects is formed, providing a comprehensive benchmark for resilience evaluation, thereby enhancing the accuracy of the resilience evaluation for the traditional village to be evaluated.

Specifically, the semantic association encoding module 340 is configured to perform semantic association encoding on the multi-source semantic aggregation matrix for the resilience aspects of the traditional village to be evaluated and the collection of multi-source semantic aggregation reference matrices for village resilience aspects, individually, to obtain the multi-source semantic aggregation implicit feature vector for the resilience aspects of the traditional village to be evaluated and the collection of multi-source semantic aggregation implicit reference feature vectors for village resilience aspects. It should be understood that village resilience evaluation requires consideration of multi-dimensional data, including the physical environment, the economic conditions, the socio-cultural aspects, and the governance capabilities etc. Single-dimension evaluations struggle to comprehensively reflect the overall condition of the village, which may reduce the accuracy of the resilience analysis of the model. Therefore, in the technical solutions of the disclosure, the multi-source semantic aggregation matrix for the resilience aspects of the traditional village to be evaluated is input into a resilience-related multi-source data semantic association feature encoder based on a text convolutional neural network model to enable semantic association fusion of the multi-source data for the resilience aspects of the village to be evaluated, extract multi-source semantic aggregation implicit features for the resilience aspects of the traditional village to be evaluated, and thereby obtain the multi-source semantic aggregation implicit feature vector for the resilience aspects of the traditional village to be evaluated. Similarly, the collection of multi-source semantic aggregation reference matrices for village resilience aspects is input into the resilience-related multi-source data semantic association feature encoder based on the text convolutional neural network model to individually extract semantic association aggregation features among the multi-source data within respective multi-source semantic aggregation reference matrices for village resilience aspects, to obtain the collection of multi-source semantic aggregation implicit reference feature vectors for village resilience aspects, thereby improving the accuracy of the reference data. Particularly, the text convolutional neural network, through sliding convolution operations, can effectively process and integrate multi-source data, capturing complex associations among the multi-source data for village resilience aspects, achieving deeper semantic association fusion in the feature space, and providing a more precise basis for resilience evaluation.

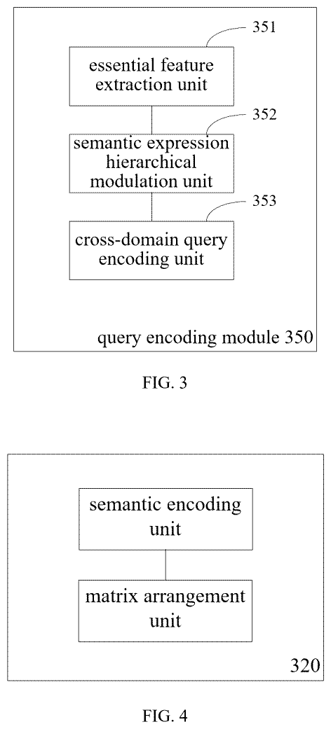

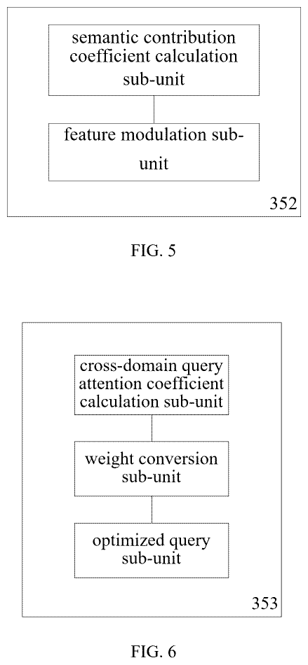

Specifically, the query encoding module 350 is configured to perform, based on essential features of the collection of multi-source semantic aggregation implicit reference feature vectors for village resilience aspects, cross-domain query encoding on the multi-source semantic aggregation implicit feature vector for the resilience aspects of the traditional village to be evaluated relative to the collection of multi-source semantic aggregation implicit reference feature vectors for village resilience aspects to obtain a semantic query response representation vector for the resilience aspects of the traditional village to be evaluated. Due to the involvement of multiple dimensions and modalities of data in village resilience evaluation, and the varying feature distributions across different multi-source semantic aggregation features for village resilience, traditional methods often struggle to effectively integrate these diverse resilience features. Therefore, in the technical solutions of the disclosure, a cross-domain query encoding method based on essential features is proposed to reduce the mutual noise interference among the resilience features of different villages. The cross-domain query encoding method learns the essential features of the collection of multi-source semantic aggregation implicit reference feature vectors for village resilience aspects, and, on this basis, conduct difference-enhancing hierarchical modulation on each multi-source semantic aggregation implicit feature vector for village resilience aspects to enhance the differentiation between the resilience features of different villages, thereby reducing noise interference and improving the capability to evaluate village resilience. In an embodiment of the disclosure, as shown in FIG. 3, the query encoding module 350 includes: an essential feature extraction unit 351, a semantic expression hierarchical modulation unit 352, and a cross-domain query encoding unit 353. The essential feature extraction unit 351 is configured to input the collection of multi-source semantic aggregation implicit reference feature vectors for village resilience aspects into an essential feature capture network to obtain a multi-source semantic aggregation reference essential feature representation vector for village resilience aspects. The semantic expression hierarchical modulation unit 352 is configured to perform, based on the multi-source semantic aggregation reference essential feature representation vector for village resilience aspects, semantic expression hierarchical modulation on each multi-source semantic aggregation implicit reference feature vector for village resilience aspects in the collection of multi-source semantic aggregation implicit reference feature vectors for village resilience aspects to obtain a collection of modulated multi-source semantic aggregation implicit reference feature vectors for village resilience aspects. The cross-domain query encoding unit 353 is configured to perform the cross-domain query encoding on the multi-source semantic aggregation implicit feature vector for the resilience aspects of the traditional village to be evaluated and the collection of modulated multi-source semantic aggregation implicit reference feature vectors for village resilience aspects to obtain the semantic query response representation vector for the resilience aspects of the traditional village to be evaluated.

Specifically, the essential feature extraction unit 351 is configured to input the collection of multi-source semantic aggregation implicit reference feature vectors for village resilience aspects into the essential feature capture network to obtain the multi-source semantic aggregation reference essential feature representation vector for village resilience aspects. That is, the collection of multi-source semantic aggregation implicit reference feature vectors for village resilience aspects is input into the essential feature capture network designed to extract intrinsic attributes or core structures from the data. The essential feature capture network is adapted to learn and extract complex multimodal temporal correlation patterns of reference state parameters from the collection of multi-source semantic aggregation implicit reference feature vectors for village resilience aspects, and compress them into a fixed-length essential feature representation vector for reference state parameters, preserving important information, reducing noise, and providing a reference anchor for subsequent processing. In the technical solutions of the disclosure, the essential feature capture network can extract features that most accurately reflect the essence of village resilience from multi-source data. These features enable a more precise description of the village resilience level, thereby improving the quality and credibility of the evaluation, and ultimately obtaining the multi-source semantic aggregation reference essential feature representation vector for village resilience aspects.

More specifically, in an embodiment of the disclosure, the input the collection of multi-source semantic aggregation implicit reference feature vectors for village resilience aspects into an essential feature capture network to obtain a multi-source semantic aggregation reference essential feature representation vector for village resilience aspects specifically includes the following steps:
firstly, calculating, for each multi-source semantic aggregation implicit reference feature vector for village resilience aspects in the collection of multi-source semantic aggregation implicit reference feature vectors for village resilience aspects, a semantic difference coefficient relative to other multi-source semantic aggregation implicit reference feature vectors for village resilience aspects to thereby obtain a collection of multi-source semantic aggregation reference semantic difference coefficients for village resilience aspects;
taking an opposite of each multi-source semantic aggregation reference semantic difference coefficient for village resilience aspects in the collection of multi-source semantic aggregation reference semantic difference coefficients for village resilience aspects, and performing normalization processing based on a Softmax function to obtain a collection of multi-source semantic aggregation reference essential semantic relevance factors for village resilience aspects; and calculating, using the collection of multi-source semantic aggregation reference essential semantic relevance factors for village resilience aspects as a weight collection, a position-wise weighted sum of the collection of multi-source semantic aggregation implicit reference feature vectors for village resilience aspects to obtain the multi-source semantic aggregation reference essential feature representation vector for village resilience aspects.

The calculating, for each multi-source semantic aggregation implicit reference feature vector for village resilience aspects in the collection of multi-source semantic aggregation implicit reference feature vectors for village resilience aspects, a semantic difference coefficient relative to other multi-source semantic aggregation implicit reference feature vectors for village resilience aspects specifically includes: calculating a mean of L1 norms of position-wise differential vectors between each multi-source semantic aggregation implicit reference feature vector for village resilience aspects and other multi-source semantic aggregation implicit reference feature vectors for village resilience aspects in the collection. The mean serves as the multi-source semantic aggregation reference semantic difference coefficient for village resilience aspects of a corresponding multi-source semantic aggregation implicit reference feature vector for village resilience aspects.

In the above embodiment, the essential feature extraction formula is used to perform essential feature extraction on the collection of multi-source semantic aggregation implicit reference feature vectors for village resilience aspects to obtain the multi-source semantic aggregation reference essential feature representation vector for village resilience aspects. The essential feature extraction formula is as follows:

$$x = \{ {v}_{1} , {v}_{2} , … , {v}_{i} , … , {v}_{n} \}$$

$${D}_{i} = \frac{1}{M} {\sum }_{( {v}_{i} , {v}_{j} ) ∈ V} {‖ {v}_{i} - {v}_{j} ‖}_{1}$$

$${P}_{k} = {\sum }_{( {v}_{i} , {v}_{j} ) ∈ V} \frac{exp ( - {D}_{i} )}{{\sum }_{i = 1}^{n} exp ( - {D}_{i} )} {v}_{i}$$

where X represents the collection of multi-source semantic aggregation implicit reference feature vectors for village resilience aspects; v₁ represents a first multi-source semantic aggregation implicit reference feature vector for village resilience aspects in the collection of multi-source semantic aggregation implicit reference feature vectors for village resilience aspects, v₂ represents a second multi-source semantic aggregation implicit reference feature vector for village resilience aspects in the collection of multi-source semantic aggregation implicit reference feature vectors for village resilience aspects, v₁ represents an i-th multi-source semantic aggregation implicit reference feature vector for village resilience aspects in the collection of multi-source semantic aggregation implicit reference feature vectors for village resilience aspects, vₙ represents an n-th multi-source semantic aggregation implicit reference feature vector for village resilience aspects in the collection of multi-source semantic aggregation implicit reference feature vectors for village resilience aspects, and n represents a number of multi-source semantic aggregation implicit reference feature vectors for village resilience aspects; exp(·) represents an exponential operation; I·I₁ represents an L1-norm of a vector; Dᵢ represents the multi-source semantic aggregation reference semantic difference coefficient for village resilience aspects corresponding to the i-th multi-source semantic aggregation implicit reference feature vector for village resilience aspects; and Pₖ represents the multi-source semantic aggregation reference essential feature representation vector for village resilience aspects.

In an embodiment, the semantic expression hierarchical modulation unit 352 includes a semantic contribution coefficient calculation sub-unit and a feature modulation sub-unit. The semantic contribution coefficient calculation sub-unit is configured to calculate a multi-source semantic aggregation reference semantic contribution coefficient for village resilience aspects between each multi-source semantic aggregation implicit reference feature vector for village resilience aspects in the collection of multi-source semantic aggregation implicit reference feature vectors for village resilience aspects and the multi-source semantic aggregation reference essential feature representation vector for village resilience aspects to obtain a collection of multi-source semantic aggregation reference semantic contribution coefficients for village resilience aspects. The feature modulation sub-unit is configured to perform, based on the collection of multi-source semantic aggregation reference semantic contribution coefficients for village resilience aspects, hierarchical modulation on the collection of multi-source semantic aggregation implicit reference feature vectors for village resilience aspects to obtain the collection of modulated multi-source semantic aggregation implicit reference feature vectors for village resilience aspects.

Specifically, the semantic expression hierarchical modulation unit 352 is configured to perform, based on the multi-source semantic aggregation reference essential feature representation vector for village resilience aspects, semantic expression hierarchical modulation on each multi-source semantic aggregation implicit reference feature vector for village resilience aspects in the collection of multi-source semantic aggregation implicit reference feature vectors for village resilience aspects to obtain the collection of modulated multi-source semantic aggregation implicit reference feature vectors for village resilience aspects. That is, in the embodiment of the disclosure, firstly, a multi-source semantic aggregation reference semantic contribution coefficient for village resilience aspects between each multi-source semantic aggregation implicit reference feature vector for village resilience aspects in the collection of multi-source semantic aggregation implicit reference feature vectors for village resilience aspects and the multi-source semantic aggregation reference essential feature representation vector for village resilience aspects is calculated, so as to determine the specific contribution degree of each multi-source semantic aggregation implicit reference feature vector for village resilience aspects to the overall multi-source semantic aggregation expression for resilience aspects, to thereby obtain a collection of multi-source semantic aggregation reference semantic contribution coefficients for village resilience aspects. Subsequently, based on the collection of multi-source semantic aggregation reference semantic contribution coefficients for village resilience aspects, hierarchical modulation is performed on the collection of multi-source semantic aggregation implicit reference feature vectors for village resilience aspects, so as to amplify the differences in the essential semantic expressions among various multi-source semantic aggregation implicit reference feature vectors for village resilience aspects in the collection of multi-source semantic aggregation implicit reference feature vectors for village resilience aspects, to thereby obtain the collection of modulated multi-source semantic aggregation implicit reference feature vectors for village resilience aspects. By performing hierarchical modulation on the collection of multi-source semantic aggregation implicit reference feature vectors for village resilience aspects, the key resilience features in multi-source semantic aggregation implicit reference features are assigned higher weights to enhance the expressiveness of key resilience features while suppressing the influence of secondary resilience features. Enhancing the expressiveness of key resilience features can improve the discriminability between different resilience features, making it easier for the model to recognize and distinguish different village resilience features. Thus, the model can better focus on those features crucial for the final decision-making, thereby improving its robustness and generalization capability.

Specifically, the calculate a multi-source semantic aggregation reference semantic contribution coefficient for village resilience aspects between each multi-source semantic aggregation implicit reference feature vector for village resilience aspects in the collection of multi-source semantic aggregation implicit reference feature vectors for village resilience aspects and the multi-source semantic aggregation reference essential feature representation vector for village resilience aspects includes: calculating a Mahalanobis distance between each multi-source semantic aggregation implicit reference feature vector in the collection of multi-source semantic aggregation implicit reference feature vectors for village resilience aspects and the multi-source semantic aggregation reference essential feature representation vector for village resilience aspects to obtain the collection of multi-source semantic aggregation reference semantic contribution coefficients for village resilience aspects.

More specifically, the perform, based on the collection of multi-source semantic aggregation reference semantic contribution coefficients for village resilience aspects, hierarchical modulation on the collection of multi-source semantic aggregation implicit reference feature vectors for village resilience aspects includes the following steps:
setting a first mask threshold and a second mask threshold, where the second mask threshold is twice the value of the first mask threshold;
performing two-fold amplification on a feature value of a multi-source semantic aggregation implicit reference feature vector for village resilience aspects, when the feature value is greater than the second mask threshold;
keeping a feature value of a multi-source semantic aggregation implicit reference feature vector for village resilience aspects unchanged, when the feature value is greater than the first mask threshold, and less than or equal to the second mask threshold;
performing two-fold reduction on a feature value of a multi-source semantic aggregation implicit reference feature vector for village resilience aspects unchanged, when the feature value is less than or equal to the first mask threshold;
thereby obtaining the collection of modulated multi-source semantic aggregation implicit reference feature vectors for village resilience aspects.

In the above embodiment, based on the multi-source semantic aggregation reference essential feature representation vector for village resilience aspects, the semantic expression hierarchical modulation is applied to each multi-source semantic aggregation implicit reference feature vector for village resilience aspects in the collection of multi-source semantic aggregation reference feature vectors for village resilience aspects to obtain the collection of modulated multi-source semantic aggregation implicit reference feature vectors for village resilience aspects, through the following semantic expression hierarchical modulation formula:

$${C}_{i} \sqrt{{( {v}_{i} - {P}_{k} )}^{T} {S}^{- 1} ( {v}_{i} - {P}_{k} )}$$

$${v}_{i} = mask ( {v}_{i} ) = \{ \text{} \begin{matrix}2 {v}_{i} & {C}_{i} > 2 θ \\ {v}_{i} & θ < {C}_{i} \leq 2 θ \\ \frac{1}{2} {v}_{i} & {C}_{i} \leq θ\end{matrix} \text{}$$

where S represents a covariance matrix, Cᵢ represents the multi-source semantic aggregation reference semantic contribution coefficient for village resilience aspects corresponding to the i-th multi-source semantic aggregation implicit reference feature vector for village resilience aspects, mask(·) represents masking processing, θ represents a predetermined threshold, and v₁ represents the collection of modulated multi-source semantic aggregation implicit reference feature vectors for village resilience aspects.

In an embodiment, the cross-domain query encoding unit 353 includes a cross-domain query attention coefficient calculation sub-unit, a weight conversion sub-unit, and an optimized query sub-unit. The cross-domain query attention coefficient calculation sub-unit is configured to input the multi-source semantic aggregation implicit feature vector for the resilience aspects of the traditional village to be evaluated and each modulated multi-source semantic aggregation implicit reference feature vector for village resilience aspects in the collection of modulated multi-source semantic aggregation implicit reference feature vectors for village resilience aspects into a cross-domain query encoding attention network to obtain a collection of multi-source semantic aggregation cross-domain query attention coefficients for the resilience aspects of the traditional village to be evaluated. The weight conversion sub-unit is configured to input the collection of multi-source semantic aggregation cross-domain query attention coefficients for the resilience aspects of the traditional village to be evaluated into a weight conversion network based on a sigmoid activation function to obtain a collection of multi-source semantic aggregation cross-domain query attention weights for the resilience aspects of the traditional village to be evaluated. The optimized query sub-unit is configured to calculate, using the collection of multi-source semantic aggregation cross-domain query attention weights for the resilience aspects of the traditional village to be evaluated as a second weight collection, a second position-wise weighted sum of the collection of multi-source semantic aggregation implicit reference feature vectors for village resilience aspects to obtain the semantic query response representation vector for the resilience aspects of the traditional village to be evaluated.

Specifically, the cross-domain query encoding unit 353 is configured to perform the cross-domain query encoding on the multi-source semantic aggregation implicit feature vector for the resilience aspects of the traditional village to be evaluated and the collection of modulated multi-source semantic aggregation implicit reference feature vectors for village resilience aspects to obtain the semantic query response representation vector for the resilience aspects of the traditional village to be evaluated. That is, in the embodiment of the disclosure, firstly, the multi-source semantic aggregation implicit feature vector for the resilience aspects of the traditional village to be evaluated and each modulated multi-source semantic aggregation implicit reference feature vector for village resilience aspects in the collection of modulated multi-source semantic aggregation implicit reference feature vectors for village resilience aspects are input into a cross-domain query encoding attention network, so as to generate attention scores according to the interaction between the multi-source semantic aggregation implicit feature vector for the resilience aspects of the traditional village to be evaluated and the modulated multi-source semantic aggregation implicit reference feature vectors for village resilience aspects, reflecting the correlation of different resilience feature combinations, to thereby obtain a collection of multi-source semantic aggregation cross-domain query attention coefficients for the resilience aspects of the traditional village to be evaluated. Subsequently, in order to ensure the numerical stability of the multi-source semantic aggregation cross-domain query attention weights for the resilience aspects of the traditional village to be evaluated, and to transform the multi-source semantic aggregation cross-domain query attention weights for the resilience aspects of the traditional village to be evaluated into a smooth and interpretable probability distribution, the collection of multi-source semantic aggregation cross-domain query attention coefficients for the resilience aspects of the traditional village to be evaluated is input into a weight conversion network based on a sigmoid activation function, so as to convert them into weight values within a normalized range, to thereby obtain a collection of multi-source semantic aggregation cross-domain query attention weights for the resilience aspects of the traditional village to be evaluated. This process ensures that features from respective modulated multi-source semantic aggregation implicit reference feature vectors for village resilience aspects are appropriately considered, and simultaneously, avoids issues of gradient vanishing or explosion under extreme conditions. Subsequently, using the collection of multi-source semantic aggregation cross-domain query attention weights for the resilience aspects of the traditional village to be evaluated as a second weight collection, element-wise multiplication is performed on the collection of multi-source semantic aggregation implicit reference feature vectors for village resilience aspects followed by an accumulation operation to obtain the semantic query response representation vector for the resilience aspects of the traditional village to be evaluated. Here, through the attention weights, the correlation between the multi-source semantic aggregation features of the village to be evaluated and those of labeled villages can be enhanced, optimizing the real-time status optimization query feature representation and improving the accuracy of subsequent classifier classifications.

In the above embodiment, the cross-domain query encoding formula is used to perform the cross-domain query encoding on the multi-source semantic aggregation implicit feature vector for the resilience aspects of the traditional village to be evaluated and the collection of modulated multi-source semantic aggregation implicit reference feature vectors for village resilience aspects to obtain the semantic query response representation vector for the resilience aspects of the traditional village to be evaluated. The cross-domain query encoding formula is as follows:

$${w}_{i} = \frac{{v}_{a} ⊗ {v}_{i}^{T}}{‖ {v}_{a} ‖ \cdot ‖ {v}_{i}^{′} ‖}$$

$${a}_{i} = sigmoid ( {w}_{i} )$$

$${V}_{f} = {\sum }_{i = 1} {v}_{i} {a}_{i}$$

where vₐ represents the multi-source semantic aggregation implicit feature vector for the resilience aspects of the traditional village to be evaluated, wᵢ represents a multi-source semantic aggregation cross-domain query attention coefficient for the resilience aspects of the traditional village to be evaluated corresponding to an i-th modulated multi-source semantic aggregation implicit reference feature vector for village resilience aspects, aᵢ represents an i-th multi-source semantic aggregation cross-domain query attention weight for the resilience aspects of the traditional village to be evaluated in the collection of multi-source semantic aggregation cross-domain query attention weights for the resilience aspects of the traditional village to be evaluated, sigmoid (·) represents the sigmoid function, and V_{f} represents the semantic query response representation vector for the resilience aspects of the traditional village to be evaluated.

Specifically, the resilience evaluation module 360 is configured to determine, based on the semantic query response representation vector for the resilience aspects of the traditional village to be evaluated, whether to label resilience of the traditional village to be evaluated as the first resilience evaluation label. In an embodiment of the disclosure, the semantic query response representation vector for the resilience aspects of the traditional village to be evaluated is input into a classifier-based resilience comprehensive evaluation module to obtain an evaluation result, the evaluation result is used to indicate whether to label the resilience of the traditional village to be evaluated as the first resilience evaluation label. In particular, the classifier is mainly based on machine learning and statistical methods, and learns the characteristics of different evaluation category labels through training data to classify the semantic query response representation vector for the resilience aspects of the traditional village to be evaluated. Specifically, in the technical solutions of the disclosure, the labels of the classifier include labeling the resilience of the traditional village to be evaluated as the first resilience evaluation label (first classification label), and not labeling the resilience of the traditional village to be evaluated as the first resilience evaluation label (second classification label). The classifier determines which classification label the semantic query response representation vector for the resilience aspects of the traditional village to be evaluated belongs to through the Softmax function. It is worth noting that the first classification label p1 and the second classification label p2 here do not contain artificially set concepts. In fact, in the training process, the computer model does not have the concept of “whether to label the resilience of the traditional village to be evaluated as the first resilience evaluation label”. Instead, the computer model only has two classification labels, and outputs feature probabilities under these two classification labels, that is, the sum of p1 and p2 is one. Therefore, whether to label the resilience of the traditional village to be evaluated as the first resilience evaluation label is actually transformed into a binary class probability distribution that conforms to natural laws through classification labels, essentially using the physical meaning of the natural probability distribution of the labels, rather than the linguistic textual meaning of “whether to label the resilience of the traditional village to be evaluated as the first resilience evaluation label”. Through this method, it is possible to achieve a multi-dimensional comprehensive evaluation of the resilience of the traditional village to be evaluated, ensure the scientific nature and reliability of the evaluation result, achieve classified and labeled management, and provide scientific basis and support for policy formulation and resource allocation.

In the technical solutions of the disclosure, the multi-source semantic aggregation implicit feature vector for the resilience aspects of the traditional village to be evaluated and the collection of multi-source semantic aggregation implicit reference feature vectors for village resilience aspects respectively represent the semantic correlation features of the data for the resilience aspects of the traditional village to be evaluated and the collection of multi-source semantic correlation features for village resilience aspects labeled with the first resilience evaluation label. However, considering that there may be interference signals or noise components in the collection of multi-source semantic aggregation reference matrices for village resilience aspects labeled with the first resilience evaluation label, when performing cross-domain query encoding based on essential feature hierarchical modulation on the multi-source semantic aggregation implicit feature vector for the resilience aspects of the traditional village to be evaluated and the collection of multi-source semantic aggregation implicit reference feature vectors for village resilience aspects, the obtained semantic query response representation vector for the resilience aspects of the traditional village to be evaluated may be mixed with interference components. These interference components will cause the semantic query response representation vector for the resilience aspects of the traditional village to be evaluated to exhibit a dynamic drift in the class-target probability mapping within the high-dimensional feature space, affect the convergence consistency of the classifier, and affect the accuracy of the evaluation result obtained by inputting the semantic query response representation vector for the resilience aspects of the traditional village to be evaluated into the classifier-based resilience comprehensive evaluation module.

In the technical solutions of the disclosure, the input the semantic query response representation vector for the resilience aspects of the traditional village to be evaluated into a classifier-based resilience comprehensive evaluation module to obtain an evaluation result includes the following steps.

A semantic query response probability value p for the resilience aspects of the traditional village to be evaluated is determined by inputting the semantic query response representation vector for the resilience aspects of the traditional village to be evaluated into the classifier-based resilience comprehensive evaluation module. The semantic query response probability value p for the resilience aspects of the traditional village to be evaluated represents the probability of labeling the resilience of the traditional village to be evaluated as the first resilience evaluation label.

A feature mean of the semantic query response representation vector for the resilience aspects of the traditional village to be evaluated is multiplied by the semantic query response probability value for the resilience aspects of the traditional village to be evaluated to obtain a semantic query response statistical field value for the resilience aspects of the traditional village to be evaluated through the following formula: n=μp; where μ represents the feature mean of the semantic query response representation vector for the resilience aspects of the traditional village to be evaluated, p represents the semantic query response probability value for the resilience aspects of the traditional village to be evaluated, and n represents the semantic query response statistical field value for the resilience aspects of the traditional village to be evaluated.

The semantic query response statistical field value for the resilience aspects of the traditional village to be evaluated is subtracted by one, and then divided by the semantic query response statistical field value for the resilience aspects of the traditional village to be evaluated to obtain a semantic query response partial probability value for the resilience aspects of the traditional village to be evaluated through the following formula: ρ=(n−1)/n, where ρ represents the semantic query response partial probability value for the resilience aspects of the traditional village to be evaluated.

A power function V^{⊙ρ} of the semantic query response representation vector for the resilience aspects of the traditional village to be evaluated raised to an exponent of the semantic query response partial probability value for the resilience aspects of the traditional village to be evaluated is calculated, and then subjected to an element-wise multiplication with the semantic query response partial probability value for the resilience aspects of the traditional village to be evaluated to obtain a semantic query response microscopic representation vector for the resilience aspects of the traditional village to be evaluated, through the following formula: V₁=ρ⊙V^{⊙ρ}, where V^{⊙ρ} represents the power function, V₁ represents the semantic query response microscopic representation vector for the resilience aspects of the traditional village to be evaluated, and ⊙ represents the element-wise multiplication.

After an element-wise multiplication of the semantic query response representation vector for the resilience aspects of the traditional village to be evaluated with the semantic query response partial probability value for the resilience aspects of the traditional village to be evaluated, an exponential function with a natural constant as the base is calculated to obtain a semantic query response macroscopic mapping vector for the resilience aspects of the traditional village to be evaluated, through the following formula: V₂=exp(V⊙ρ), where V₂ represents the semantic query response macroscopic mapping vector for the resilience aspects of the traditional village to be evaluated.

The base-2 logarithm of the semantic query response microscopic representation vector for the resilience aspects of the traditional village to be evaluated is calculated, and then a weighted summation is performed with the semantic query response macroscopic mapping vector to obtain an optimized semantic query response representation vector for the resilience aspects of the traditional village to be evaluated, through the following formula: V′=(α⊙ log₂ V₁)⊕(β⊙V₂), where α and β represent weighting hyperparameters, ⊕ represents element-wise addition, and V′ represents the optimized semantic query response representation vector for the resilience aspects of the traditional village to be evaluated.

The optimized semantic query response representation vector for the resilience aspects of the traditional village to be evaluated is input into the classifier-based resilience comprehensive evaluation module to obtain the evaluation result.

In an embodiment, each of the data acquisition module 310, the multi-source semantic aggregation module for the resilience aspects of the traditional village to be evaluated 320, the first resilience evaluation label extraction module 330, the semantic association encoding module 340, the query encoding module 350, the resilience evaluation module 360, and the classifier-based resilience comprehensive evaluation module is embodied by at least one processor and at least one memory coupled to the at least one processor, and the at least one memory stores computer programs executable by the at least one processor. Each of the semantic encoding unit, the matrix arrangement unit, the essential feature extraction unit 351, the semantic expression hierarchical modulation unit 352, the cross-domain query encoding unit 353, the semantic contribution coefficient calculation sub-unit, the feature modulation sub-unit, the cross-domain query attention coefficient calculation sub-unit, the weight conversion sub-unit, and the optimized query sub-unit is embodied by at least one processor and at least one memory coupled to the at least one processor, and the at least one memory stores computer programs executable by the at least one processor.

Therefore, by using the low-order partial derivatives of the statistical distribution field corresponding to the semantic query response representation vector for the resilience aspects of the traditional village to be evaluated as non-overlapping macroscopic feature representation behavior patches for the semantic query response representation vector for the resilience aspects of the traditional village to be evaluated, and based on the organizational space of different macroscopic behavior patches under the non-isotropic backbone structure of the semantic query response representation vector for the resilience aspects of the traditional village to be evaluated, the dynamic sensitivity of the long-range sequence microscopic complex information distribution of the semantic query response representation vector for the resilience aspects of the traditional village to be evaluated to the macroscopic representation behavior of class probability is enhanced. Thereby, the iterative dynamic consistency between the class target and the extracted features during the feature space-class probability mapping is promoted, improving the accuracy of the evaluation result obtained by inputting the semantic query response representation vector for the resilience aspects of the traditional village to be evaluated into the classifier-based resilience comprehensive evaluation module.

In an embodiment, the resilience evaluation module is further configured to send a warning message to prompt personnel to take corresponding measures on the traditional village to be evaluated, when the traditional village to be evaluated is not labeled as the first resilience evaluation label. For example, when the physical environment resilience of the traditional village to be evaluated does not meet the criteria of the first resilience evaluation label, the resilience evaluation module sends an environmental warning message showing natural disaster information such as the possibility of earthquake or landslide to the personnel, and the personnel may evacuate villagers of the traditional village to be evaluated according to the environmental warning message.

In an embodiment, the comprehensive resilience evaluation system 300 may be integrated with the GIS, and the resilience evaluation module is further configured to generate, based on the evaluation result and the village spatial layer from the GIS, a resilience distribution map of the traditional village to realize spatial visualization of the evaluation result.

As described above, the comprehensive resilience evaluation system 300 for the traditional village according to the embodiments of the disclosure can be implemented in various wireless terminals, such as servers equipped with the traditional village resilience comprehensive evaluation algorithm. In an embodiment, the comprehensive resilience evaluation system 300 for the traditional village according to the embodiments of the disclosure can be integrated into a wireless terminal as a software module and/or a hardware module. For example, the comprehensive resilience evaluation system 300 for the traditional village can be a software module within the operating system of the wireless terminal, or can be an application program developed for the wireless terminal; certainly, the comprehensive resilience evaluation system 300 for the traditional village can likewise be one of the numerous hardware modules of the wireless terminal.

Alternatively, in an embodiment, the comprehensive resilience evaluation system 300 for the traditional village and the wireless terminal can also be separate devices. Furthermore, the comprehensive resilience evaluation system 300 for the traditional village can be connected to the wireless terminal via a wired and/or wireless network, and interactive information is transmitted according to a pre-agreed data format.

The various embodiments of the present disclosure have been described above. The above description is illustrative and is not exhaustive, nor is it limited to the disclosed embodiments. Many modifications and variations will be readily apparent to those skilled in the art without departing from the scope and spirit of the illustrated embodiments. The selection of terms used herein is intended to best explain the principles of the embodiments, their practical applications, or improvements to technology in the marketplace, or to enable others of ordinary skill in the art to understand the embodiments disclosed herein.

What is claimed is:

1. A comprehensive resilience evaluation system for a traditional village, comprising:
a data acquisition module, configured to acquire a set of data for resilience aspects of a traditional village to be evaluated;
a multi-source semantic aggregation module for the resilience aspects of the traditional village to be evaluated, configured to perform semantic encoding and structured processing on the set of the data for the resilience aspects of the traditional village to be evaluated to obtain a multi-source semantic aggregation matrix for the resilience aspects of the traditional village to be evaluated;
a first resilience evaluation label extraction module, configured to extract, from a backend database, a collection of multi-source semantic aggregation reference matrices for village resilience aspects labeled with a first resilience evaluation label;
a semantic association encoding module, configured to perform semantic association encoding on the multi-source semantic aggregation matrix for the resilience aspects of the traditional village to be evaluated and the collection of multi-source semantic aggregation reference matrices for village resilience aspects, individually, to obtain a multi-source semantic aggregation implicit feature vector for the resilience aspects of the traditional village to be evaluated and a collection of multi-source semantic aggregation implicit reference feature vectors for village resilience aspects;
a query encoding module, configured to perform, based on essential features of the collection of multi-source semantic aggregation implicit reference feature vectors for village resilience aspects, cross-domain query encoding on the multi-source semantic aggregation implicit feature vector for the resilience aspects of the traditional village to be evaluated relative to the collection of multi-source semantic aggregation implicit reference feature vectors for village resilience aspects to obtain a semantic query response representation vector for the resilience aspects of the traditional village to be evaluated; and
a resilience evaluation module, configured to determine, based on the semantic query response representation vector for the resilience aspects of the traditional village to be evaluated, whether to label resilience of the traditional village to be evaluated as the first resilience evaluation label;
wherein the query encoding module comprises:
an essential feature extraction unit, configured to input the collection of multi-source semantic aggregation implicit reference feature vectors for village resilience aspects into an essential feature capture network to obtain a multi-source semantic aggregation reference essential feature representation vector for village resilience aspects;
a semantic expression hierarchical modulation unit, configured to perform, based on the multi-source semantic aggregation reference essential feature representation vector for village resilience aspects, semantic expression hierarchical modulation on each multi-source semantic aggregation implicit reference feature vector for village resilience aspects in the collection of multi-source semantic aggregation implicit reference feature vectors for village resilience aspects to obtain a collection of modulated multi-source semantic aggregation implicit reference feature vectors for village resilience aspects; and
a cross-domain query encoding unit, configured to perform the cross-domain query encoding on the multi-source semantic aggregation implicit feature vector for the resilience aspects of the traditional village to be evaluated and the collection of modulated multi-source semantic aggregation implicit reference feature vectors for village resilience aspects to obtain the semantic query response representation vector for the resilience aspects of the traditional village to be evaluated;
wherein the essential feature extraction unit is specifically configured to:
calculate, for each multi-source semantic aggregation implicit reference feature vector for village resilience aspects in the collection of multi-source semantic aggregation implicit reference feature vectors for village resilience aspects, a semantic difference coefficient relative to other multi-source semantic aggregation implicit reference feature vectors for village resilience aspects to thereby obtain a collection of multi-source semantic aggregation reference semantic difference coefficients for village resilience aspects;
take an opposite of each multi-source semantic aggregation reference semantic difference coefficient for village resilience aspects in the collection of multi-source semantic aggregation reference semantic difference coefficients for village resilience aspects, and perform normalization processing based on a Softmax function to obtain a collection of multi-source semantic aggregation reference essential semantic relevance factors for village resilience aspects; and
calculate, using the collection of multi-source semantic aggregation reference essential semantic relevance factors for village resilience aspects as a weight collection, a position-wise weighted sum of the collection of multi-source semantic aggregation implicit reference feature vectors for village resilience aspects to obtain the multi-source semantic aggregation reference essential feature representation vector for village resilience aspects.

2. The comprehensive resilience evaluation system for the traditional village as claimed in claim 1, wherein the data for the resilience aspects comprises descriptions of a physical environment, descriptions of economic conditions, descriptions of socio-cultural aspects, and descriptions of management mechanisms.

3. The comprehensive resilience evaluation system for the traditional village as claimed in claim 2, wherein the multi-source semantic aggregation module for the resilience aspects of the traditional village to be evaluated comprises:
a semantic encoding unit, configured to perform the semantic encoding on the descriptions of the physical environment, the descriptions of the economic conditions, the descriptions of the socio-cultural aspects, and the descriptions of the management mechanisms, individually, to obtain a collection of description semantic encoding vectors for the resilience aspects of the traditional village to be evaluated, wherein the collection of description semantic encoding vectors for the resilience aspects of the traditional village to be evaluated comprises a physical environment description semantic encoding vector, an economic condition description semantic encoding vector, a socio-cultural aspect description semantic encoding vector, and a management mechanism description semantic encoding vector; and
a matrix arrangement unit, configured to arrange the collection of description semantic encoding vectors for the resilience aspects of the traditional village to be evaluated into a matrix to obtain the multi-source semantic aggregation matrix for the resilience aspects of the traditional village to be evaluated.

4. The comprehensive resilience evaluation system for the traditional village as claimed in claim 3, wherein the semantic association encoding module is configured to:
perform, using a resilience-related multi-source data semantic association feature encoder based on a text convolutional neural network model, the semantic association encoding on the multi-source semantic aggregation matrix for the resilience aspects of the traditional village to be evaluated and the collection of multi-source semantic aggregation reference matrices for village resilience aspects, individually, to obtain the multi-source semantic aggregation implicit feature vector for the resilience aspects of the traditional village to be evaluated and the collection of multi-source semantic aggregation implicit reference feature vectors for village resilience aspects.

5. The comprehensive resilience evaluation system for the traditional village as claimed in claim 4, wherein the semantic expression hierarchical modulation unit comprises:
a semantic contribution coefficient calculation sub-unit, configured to calculate a multi-source semantic aggregation reference semantic contribution coefficient for village resilience aspects between each multi-source semantic aggregation implicit reference feature vector for village resilience aspects in the collection of multi-source semantic aggregation implicit reference feature vectors for village resilience aspects and the multi-source semantic aggregation reference essential feature representation vector for village resilience aspects to obtain a collection of multi-source semantic aggregation reference semantic contribution coefficients for village resilience aspects; and
a feature modulation sub-unit, configured to perform, based on the collection of multi-source semantic aggregation reference semantic contribution coefficients for village resilience aspects, hierarchical modulation on the collection of multi-source semantic aggregation implicit reference feature vectors for village resilience aspects to obtain the collection of modulated multi-source semantic aggregation implicit reference feature vectors for village resilience aspects.

6. The comprehensive resilience evaluation system for the traditional village as claimed in claim 5, wherein the cross-domain query encoding unit comprises:
a cross-domain query attention coefficient calculation sub-unit, configured to input the multi-source semantic aggregation implicit feature vector for the resilience aspects of the traditional village to be evaluated and each modulated multi-source semantic aggregation implicit reference feature vector for village resilience aspects in the collection of modulated multi-source semantic aggregation implicit reference feature vectors for village resilience aspects into a cross-domain query encoding attention network to obtain a collection of multi-source semantic aggregation cross-domain query attention coefficients for the resilience aspects of the traditional village to be evaluated;
a weight conversion sub-unit, configured to input the collection of multi-source semantic aggregation cross-domain query attention coefficients for the resilience aspects of the traditional village to be evaluated into a weight conversion network based on a sigmoid activation function to obtain a collection of multi-source semantic aggregation cross-domain query attention weights for the resilience aspects of the traditional village to be evaluated; and
an optimized query sub-unit, configured to calculate, using the collection of multi-source semantic aggregation cross-domain query attention weights for the resilience aspects of the traditional village to be evaluated as a second weight collection, a second position-wise weighted sum of the collection of multi-source semantic aggregation implicit reference feature vectors for village resilience aspects to obtain the semantic query response representation vector for the resilience aspects of the traditional village to be evaluated.

7. The comprehensive resilience evaluation system for the traditional village as claimed in claim 6, wherein the resilience evaluation module is specifically configured to:
input the semantic query response representation vector for the resilience aspects of the traditional village to be evaluated into a classifier-based resilience comprehensive evaluation module to obtain an evaluation result, wherein the evaluation result is used to indicate whether to label the resilience of the traditional village to be evaluated as the first resilience evaluation label.
